(19) United States
(12) Patent Application Publication
(10) Pub. No.: US 2026/0128624 A1
(43) Pub. Date: May 7, 2026

(54) SEGMENTED ARMATURE STATOR ASSEMBLY FOR ELECTROMAGNETIC MOTOR

(71) Applicant: KOLLMORGEN CORPORATION, Radford, VA (US)

(72) Inventors: Jeffrey Todd BREWSTER, Dublin, VA (US); Ronald Wesley KLUEVER, Wake Forest, NC (US); William Edward ANDERSON, IV, Blacksburg, VA (US); Samuel SHIVER, Christiansburg, VA (US); Stephen John FUNK, Riner, VA (US); Jacob ABER, Christiansburg, VA (US)

(73) Assignee: KOLLMORGEN CORPORATION, Radford, VA (US)

(21) Appl. No.: 19/376,001

(22) Filed: Oct. 31, 2025

Related U.S. Application Data
(60) Provisional application No. 63/715,238, filed on Nov. 1, 2024.

(51) Int. Cl. H02K 1/14; H02K 3/18

(52) U.S. Cl. CPC H02K 1/14; H02K 3/18

(57) ABSTRACT

A stator armature assembly for an electromagnetic motor. The stator armature assembly has an elongated wheel having a plurality of radial teeth. Further, stator armature assembly has a plurality of windings, each winding being mounted on one of the plurality of radial teeth. The stator armature assembly also has a yoke having at least two segments joined together, and radially disposed around the wheel and the plurality of windings.

### CROSS REFERENCE TO RELATED APPLICATIONS

The present application claims the benefit of and priority to U.S. Provisional Patent Application No. 63/715,238, filed on Nov. 1, 2024, the entirety of which is incorporated herein by reference for any purpose whatsoever.

### FIELD OF THE DISCLOSURE

The subject disclosure relates to electromagnetic motors, and more particularly to a segmented armature stator of an electromagnetic motor.

### BACKGROUND

Brushless rotary motors are a type of electric motor that do not rely on brushes to commutate current. Instead, in these motors, the rotor, which is the rotating part, typically includes permanent magnets arranged on extended sections known as “poles.” Surrounding the rotor is a stator, which is the stationary part of the motor. The rotor and stator are typically circular and ring-shaped. The rotor may be coupled to a shaft or the like for providing a rotational driving force thereto.

Referring to FIG. 1, an armature 1 for a prior art stator (not shown) is illustrated. The armature 1 has a plurality of layers 2 a, 2 b that are Stacked and Laminated Together. The layers 2 2a, 2b are differently shaped so that the bridge 10 forms slot opening windows 12. The laminated armature 1 forms multiple radial teeth 4 equally spaced around a central circular hub 6 and forms intermittent open areas or slots 8.

When assembled, the armature slots 8 are filled with coils (not shown) of wire so that when electrical current flows through the coils, the coils induce electromagnetic fields within the teeth 4. The fields interact with the permanent magnets in the rotor (not shown), inducing torque and causing the rotor to rotate. By controlling the direction of the current through the coils, and thereby the electromagnetic field in the stator teeth 4, the rotor can be synchronously rotated.

Despite the basic design of brushless motors, improving their performance—especially in terms of torque and output power—remains a significant engineering challenge. A key factor affecting performance is copper losses, which are the energy losses due to resistance in the copper windings of the stator. These losses directly impact the motor's efficiency. To minimize copper losses, a common approach is to increase the amount of copper in the stator windings, a concept referred to as copper slot fill. Copper slot fill refers to the proportion of the available area in the stator that is filled with copper, e.g., the slot. A higher copper slot fill reduces resistance and, consequently, copper losses, leading to improved motor efficiency.

However, increasing the copper slot fill is not without its challenges. Many existing methods for achieving this involve complex manufacturing processes that make the motor more difficult and expensive to produce.

The armature coil windings can be wound via many manufacturing methods. The windings can be formed manually turn-by-turn around the armature teeth to fill the slots. Coils can also be wound externally and inserted by hand into the armature slots. Hand winding methods have long processing times and limited slot fills can be achieved. Automatic machine winding methods utilize needles to feed the wire into the slots around the armature teeth. The needle winders achieve good layering and copper fill, but the overall slot fill is reduced because the needle area must be left open for the needle to pass therethrough.

Another such method is the use of segmented T-core armatures, as described in U.S. Pat. No. 10,468,930 entitled Segmented Brushless Stator Interconnect System issued to Kollmorgen Corporation on Nov. 5, 2019. In this design, the stator is divided into multiple segments, each containing a T-shaped core that allows for high-density winding placement. While this design increases copper slot fill and can enhance performance, it also introduces significant manufacturing difficulties. Specifically, the segmented design requires all the individual segments to be reassembled into a complete armature stator, a process that can be time-consuming and error prone. These complications can result in a trade-off where the motor's overall performance is diminished due to the complexity of the assembly process.

As would be the case with the armature 1 shown in FIG. 1, each slot 8 can be wound for the highest slot fills before being assembled with an outer circular ring (not shown) to form a completed stator. Often during insertion of the armature 1 into the outer ring, the layers 2 a, 2b are detrimentally peeled apart due to friction, which weakens the structure. Thus, the interconnecting sections 10 or bridge areas are needed for strength of the structure. However, these sections 10 can cause flux leakage, which is the unwanted escape of magnetic flux from its intended path that reduces the effectiveness of the electromagnetic field thereby reducing the torque density of the electric motor. The insertion friction during assembly also limits the axial length of the resulting motor. Alternatively, clearance is provided between the armature 1 and outer ring to the detriment of the performance of the motor. As can be seen, the assembly processes are complicated and limit the overall cost and performance effectiveness. Japanese Patent No. JP1991139146A (Yaskawa patent) discloses a method where laminated interconnected teeth are inserted axially into a laminated back iron ring. However, this approach requires larger clearances due to part tolerances, allowing the parts to slide together. If the parts are not perfectly round, assembly issues arise, leading to poor contact and airgaps between the teeth and the back iron. This inconsistency can reduce motor performance because the airgaps have a large resistance to the magnet flux thereby reducing torque density. Moreover, friction build-up during assembly limits the overall axial motor length, further constraining performance.

Further, Japanese Patent No. JP1994050939B2 (Mitsubishi patent) describes a comparable method involving a laminated teeth structure that is inserted into a laminated back iron ring. This method also faces the challenge of requiring large clearances and tolerances, which complicate assembly. In this design, the use of dove-tail features, a type of joint designed for better interlocking, adds further difficulty to the assembly process. Out-of-round parts exacerbate these problems, causing potential performance issues. Moreover, the removal of interconnected bridges during a final assembly step complicates the process further and may even compromise the structural integrity of the motor.

### SUMMARY

The present disclosure introduces a segmented back iron construction, where individual segments are radially pressed into place to establish close contact with the corresponding interconnected tooth assembly. This design offers several advantages over prior methods. First, it reduces the necessary clearance during assembly, thanks to the specific process used to fit the yoke pieces to the teeth section. Additionally, any out-of-roundness in the yoke and tooth sections are eliminated during assembly. The radial pressing and welding techniques provide an easier, more consistent and reliable assembly process. Using multiple yoke sections ensures a uniform tooth-to-yoke interface around the entire circumference.

Furthermore, due to the segmentation of the back iron yoke, separate material dies can be used during manufacturing to reduce material waste. For example, multiple arcuate yoke dies can be closely nested for maximum material efficiency to create a ring without creating a large central waster circle when a solid ring is punched. In other words, the nesting of arcuate segments is advantageous relative to using a larger die to manufacture a whole back iron yoke as a single continuous laminated ring.

Further, the present design also has the advantage of having no axial sliding friction during assembly. Radial pressing allows the number of interconnected bridges needed for structural stiffness during assembly to be minimized, increasing the torque density, while also enabling the construction of longer axial length motors. Finally, if welding is employed to join the back iron segments, potential eddy current losses are kept to a minimum such as, for example, forming the joints radially above teeth where the field is weakest.

In one embodiment, the subject disclosure includes a stator armature assembly for an electromagnetic motor. The stator armature assembly has an elongated wheel having a plurality of radial teeth and a plurality of windings, each winding being mounted on one of the plurality of radial teeth. The stator armature assembly includes a yoke having at least two segments joined together, and radially disposed around the wheel and the plurality of windings.

In another embodiment, the at least two segments may define curved lateral surfaces that, when abutting, form an annular cylinder shape radially disposed around the wheel.

The at least one tooth of the plurality of radial teeth may define a central protuberance, extending radially from a plane of a distal tip thereof. The at least two segments of the yoke each may define a tiered step extremity, the tiered step extremities and the central protuberance configured for affixation.

At least one tooth of the plurality of radial teeth may define a concave void inwardly defined from a plane of a distal tip thereof. The at least two segments of the yoke may each define a barb extremity, the barbs and the concave void configured for affixation. The at least one tooth of the plurality of teeth may define a planar surface at a distal tip thereof. The at least two segments of the yoke define a planar extremity, the planar extremities and the planar surface at the distal tip configured for affixation.

The at least two segments of the yoke may join adjacent to at least one tooth of the plurality of teeth. The yoke may have 2, 3, or 4 segments. The at least two segments may be joined radially above at least two of the plurality of radial teeth.

Further, the stator armature assembly may also have a circuit board including circuitry configured to provide electrical power to the stator armature assembly.

In one embodiment, the subject disclosure includes a stator for an electric motor. The stator has a wheel having a plurality of teeth made of magnetically-permeable material, each tooth wound with an electric coil. At least one tooth of the plurality of teeth defines an interconnection point. The stator has a yoke, each segment of the yoke radially disposed around the wheel. At least two segments of the yoke join at the interconnection point defined by the at least one tooth of the plurality of teeth.

In yet another embodiment, the subject disclosure includes a stator for an electric motor. The stator has a tooth wheel laminated stack defining a circular core and a plurality of teeth extending radially for the circular core, each tooth wound with an electric coil. The stator has a yoke, each segment of the yoke radially disposed around the wheel. Each segment joins an adjacent segment at a location abutting a tooth of the plurality of teeth. Further, the circular core defines a plurality of interconnected bridges between the plurality of teeth, at least one interconnected bridge defining a window to adjust distribution of magnetic flux in the stator.

In yet another embodiment, the subject disclosure includes a method of assembling a stator armature assembly. The method includes providing an elongated wheel having a plurality of radial teeth and a yoke having at least two segments. The method includes winding the plurality of radial teeth of the elongated wheel with electric coil. The method also includes radially pressing the at least two segments of the yoke inwardly around the elongated wheel and affixing the at least two segments to at least one of the plurality of radial teeth.

### BRIEF DESCRIPTION OF THE DRAWINGS

Various aspects of the present disclosure are discussed herein with reference to the accompanying Figures. It will be appreciated that for simplicity and clarity of illustration, elements shown in the drawings have not necessarily been drawn accurately or to scale. For example, the dimensions of some of the elements can be exaggerated relative to other elements for clarity or several physical components can be included in one functional block or element. Further, where considered appropriate, reference numerals can be repeated among the drawings to indicate corresponding or analogous elements. For purposes of clarity, however, not every component can be labeled in every drawing. The Figures are provided for the purposes of illustration and explanation and are not intended as a definition of the limits of the disclosure.

FIG. 1 illustrates an armature for a prior art stator.

FIG. 2 shows a perspective view of an electromagnetic motor with a stator armature assembly and printed circuit board in assembled form according to the subject technology.

FIG. 3 shows an isolated, perspective view of the stator armature assembly of FIG. 2 according to the subject technology.

FIG. 4A shows a partially exploded, isolated, perspective view of the stator armature assembly of FIG. 3 according to the subject technology.

FIG. 4B shows a partially exploded, isolated, perspective view of the stator armature assembly of FIG. 3, detailing a wheel and segmented yoke according to the subject technology.

FIG. 5 shows a cross-sectional view of the stator armature assembly of FIG. 4A according to the subject technology.

FIG. 6 shows a partially exploded, isolated, perspective view of the wheel of the stator armature assembly together with an electric coil according to the subject technology.

FIG. 7 shows a perspective view of the wheel together with electric coils in sub-assembled form according to the subject technology.

FIG. 8 shows a cross-sectional view of the stator armature of FIG. 4A in mid-assembly according to the subject technology.

FIG. 9 shows a flux plot, detailing an optimal location to align the segmented yoke relative to the wheel according to the subject technology.

FIG. 10 illustrates another version of a joint between the tooth and yoke according to the subject technology.

FIG. 11A illustrates an embodiment of the joint between the tooth and yoke in which the distal tip of the tooth and the inner surface of the yoke define complementary curved profiles providing continuous radial contact and uniform magnetic flux transfer according to the subject technology.

FIG. 11B illustrates an embodiment of the joint between the tooth and yoke in which the distal tip of the tooth defines a more pointed convex profile engaging a corresponding concave surface of the yoke to provide enhanced centering and controlled contact pressure according to the subject technology.

FIG. 11C illustrates an embodiment of the joint between the tooth and yoke in which alternating teeth define curved and planar distal tips respectively that engage corresponding alternating concave and planar regions of the yoke to balance self-centering and dimensional control according to the subject technology.

FIG. 12A illustrates an embodiment of the joint between abutting yoke segments and alternating teeth, where beveled teeth support oblique seams between segment ends and planar teeth support flat portions of the yoke to provide alternating beveled and planar joint regions according to the subject technology.

FIG. 12B illustrates a cross-sectional view of the stator armature assembly incorporating the alternating beveled and planar joint configuration of FIG. 12A, showing the circumferential distribution of oblique joints above beveled teeth and planar seating regions above planar teeth according to the subject technology.

### DETAILED DESCRIPTION

The subject technology overcomes many of the prior art problems associated with electromagnetic motors. The advantages, and other features of the technology disclosed herein, will become more readily apparent to those having ordinary skill in the art from the following detailed description of certain exemplary embodiments taken in combination with the drawings and wherein like reference numerals identify similar structural elements. It should be noted that directional indications such as vertical, horizontal, upward, downward, right, left and the like, are used with respect to the figures and not meant in a limiting manner.

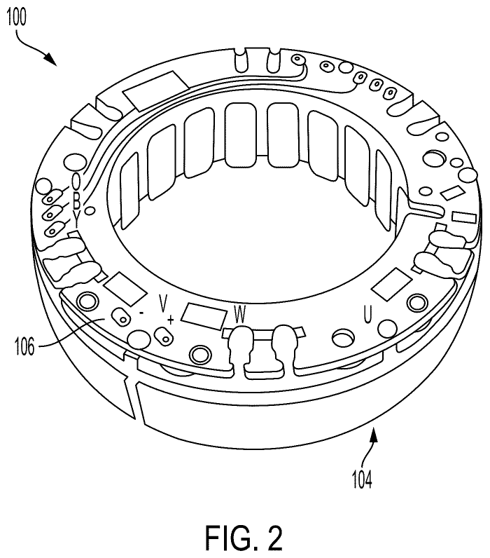

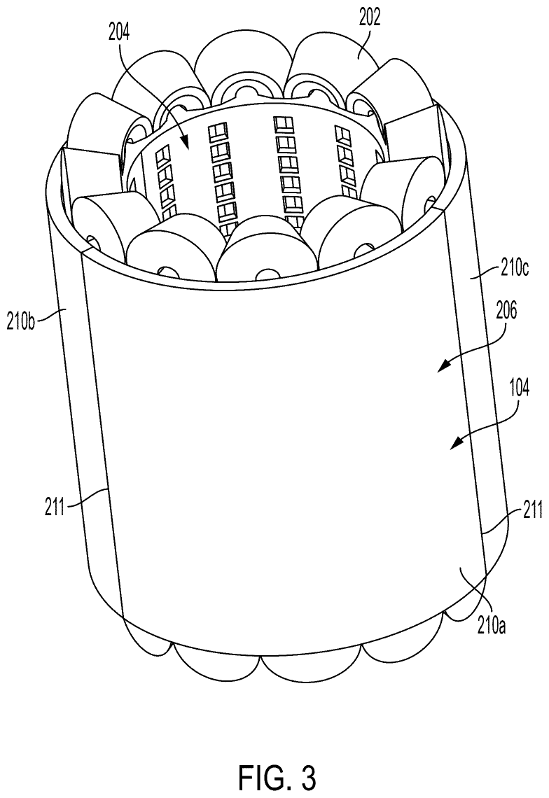

Referring now to FIG. 2, an electromagnetic motor 100 is shown in perspective in an assembled form. The motor 100 includes a rotor (not shown) driven by a stator armature assembly 104 that is controlled by a printed circuit board (PCB) 106. More particularly, the PCB 106 connects to field windings 202 (see FIG. 3) to generate the magnetic field required for motor operation, i.e., to drive the rotor.

Preferably, the PCB 106 is press-fit to be suspended above and aligned with the stator armature assembly 104. The overall shape of the motor 100 is circular, enabling seamless integration and reduction of the overall space required within a motor housing (not shown), which can be particularly beneficial in compact or high-performance applications where minimizing size and weight is critical.

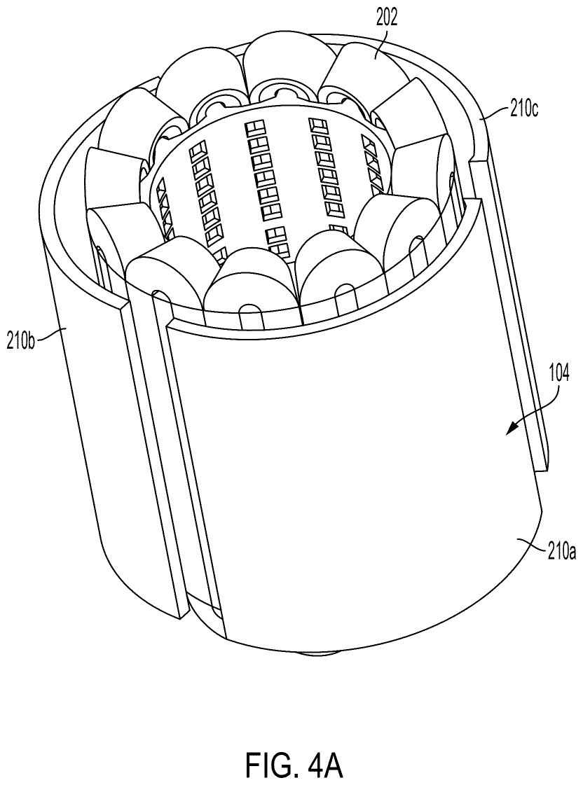

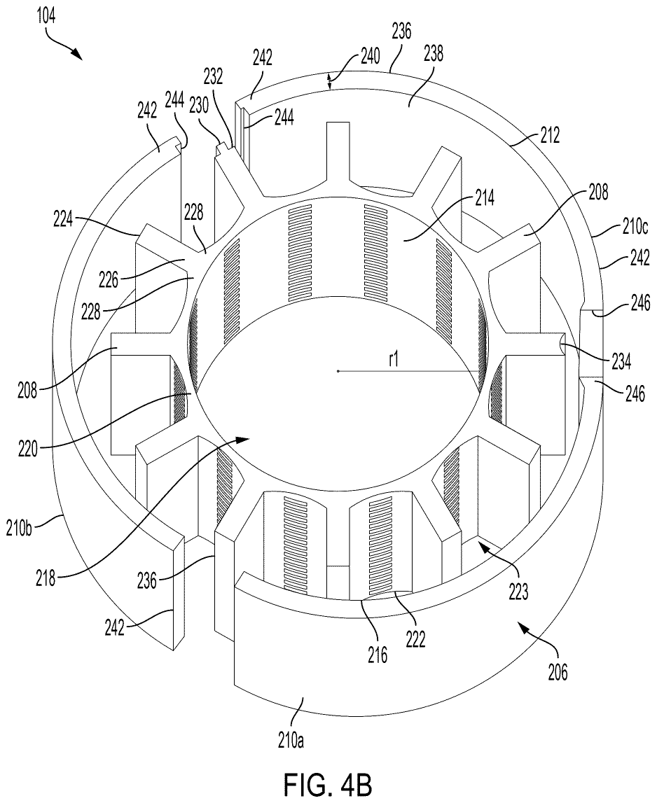

In FIG. 3, an isolated perspective view of the stator armature assembly 104 of FIG. 2 is shown. FIG. 4A illustrates a partially exploded view of the stator armature assembly 104. FIG. 4B is another exploded view of the stator armature assembly 104 with the windings 202 omitted simply to better illustrate portions of the stator armature assembly 104. With reference to the aforementioned Figures, the stator armature assembly 104 includes a wheel 204 and yoke 206. The wheel 204 includes a plurality of radial teeth 208, wherein each slot 223 is filled with winding 202. However, it should be appreciated that in alternative embodiments, a winding/coil design can span every other tooth 208, a plurality of teeth 208, or be omitted. A yoke 206 made of three segments 210a-c surrounds the wheel 204 and the windings 202. The segments 210a-c are coupled together at joints 211 formed radially above a tooth 208, which is a location that has relatively low flux density concentration, making for less disruption of the desired magnetic field and lowering potential eddy currents losses at a welded joint.

The wheel 204 has a circular core 212 defined by an inner 214 and outer 216 sidewall, the inner sidewall 214 defining a central bore 218 of which a rotor (not shown) is configured to sit within. The radius r₁ of the central bore 218 varies depending on desired magnetic field strength, torque production, and overall motor size.

Nonetheless, the wheel 204 has twelve teeth 208 extending radially from the outer sidewall 216 of the circular core 212. However, the wheel 204 may have a fewer or a greater number of teeth 208 depending on application such as, for example, 6, 9, or 18, as illustrated below.

It is envisioned that the central wheel can have any number of teeth with electric coils filling all slots around the teeth. The yoke can be any number of segments configured to be radially pressed into a fixed position around the wheel. Preferably, the number of teeth is a multiple of the number of segments so that each joint may be formed radially above a tooth. Some examples of the number of teeth or, as shown slots formed between the teeth, and yoke segments is shown in Table 1.

TABLE 1

| Slots | Yoke Segments | | |
|---|---|---|---|
| 6 | 2 | 3 | — |
| 9 | — | 3 | — |
| 12 | 2 | 3 | 4 |
| 15 | — | 3 | 5 |
| 18 | 2 | 3 | 6 |
| 24 | 2 | 3 | 4 |
| 27 | — | 3 | — |

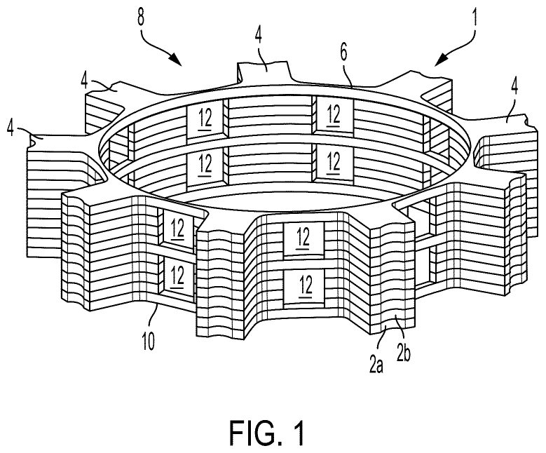

Each tooth 208 is separated by an interconnected bridge portion 220 along the circular core 212. Due to the wheel 204 being formed of many lamination stacks, the interconnected bridge portion 220 need not be present in every lamination stack to maintain structural integrity, as discussed, for example, with reference to FIG. 1. That is, the circular core 212 can form windows 222 between adjacent teeth 208 in the interconnected bridge portion 220, improving airflow and heat dissipation and enabling enhanced flux linkage between the windings 202 and rotor (not shown).

A single window 222 can correspond to the thickness of a single laminate or can also extend over a number of laminates. Further, there can also be more than one window 222 formed in the interconnected bridge portion 220, whether vertically or horizontally arranged relative to each other. It is contemplated that the windows 222 may not be provided in all interconnected bridge portions 220, but only between every second, third, fourth etc. adjacent teeth 208. In this regard, the configuration of interconnected bridge portions 220 and windows 222 can be varied relative to the inner sidewall 214 of the circular core 212 for potential skewing to reduce cogging, or make uniform torque production via adjusting distribution of magnetic flux, thus improving the performance of the motor 100. The windows 222 do not have to be rectangular, they can also be round, oval, or a variety of different shapes. Thus, a strategic design of the windows 222, in combination with skewing or varying the shape of the windows 222, can help reduce torque ripple.

The teeth 208 are evenly spaced around the circumference of the outer sidewall 216 of the circular core 212 to create uniform magnetic flux distribution. Thus, the angular spacing between two adjacent teeth 208 is calculated by dividing the full circle (360 degrees) by twelve, i.e., 30 degrees in the current embodiment. By spacing each tooth 208, a stator slot 223 forms for holding by a coil or winding 202, as contemplated below.

Each tooth 208 extends radially to a distal tip 224 from a proximal base 226, where each tooth 208 connects to the circular core 212. The base 226 of each tooth 208 is wider in contour than the respective tip 224 of the tooth 208. Put another way, the corners 228 where the tooth 208 connects to the circular core 212 are filleted, preventing stress concentrations and improving the overall mechanical integrity of the structure. This filleting ensures that the teeth 208 remain securely attached to the circular core 212 even under heavy mechanical loads during operation of the electric motor 100.

Although not directly illustrated herein, each tooth 208 may taper slightly towards the distal tip 224. Some designs may have more pronounced tapers, while others might maintain a relatively straight edge for the majority of the tooth 208 length. Further, the length of each tooth 208 is consistent across all 12 teeth 208, but can vary based on the size and application of the electric motor 100, ensuring the magnetic field generated is efficiently directed.

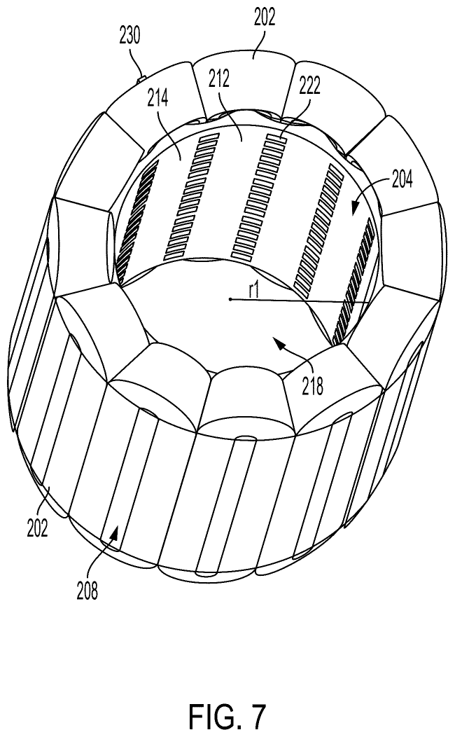

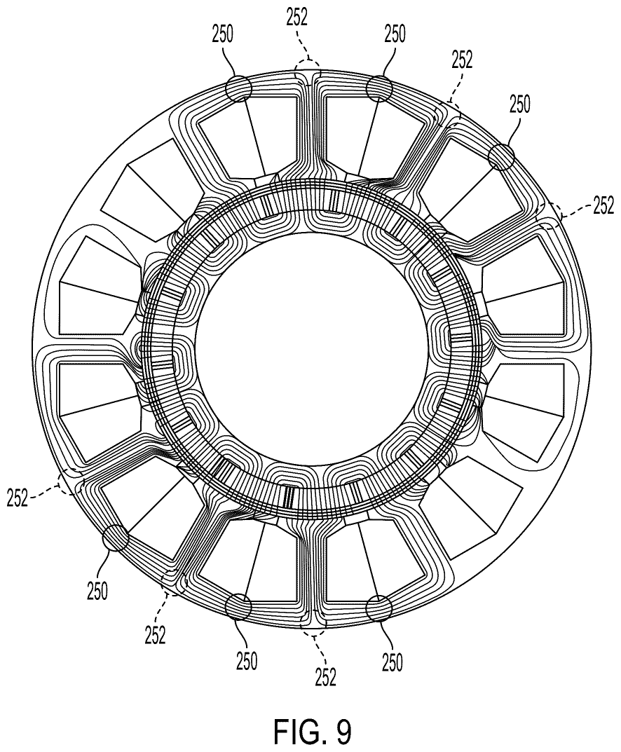

The distal tip 224 of a given tooth 208, such as exhibited in FIG. 4B, may be particularly designed so as to cooperate with the yoke 206. As shown best in FIGS. 4 and 7, the distal tips 224 can be a slightly rounded surface to match the yoke 206. In the embodiment of FIG. 9, the yoke 206 has flat portions 207 so that the distal tips 224 may be correspondingly flat.

In one embodiment, the distal tip 224 defines a central protuberance 230 extending radially from a plane 232 of the distal tip 224. In another embodiment, the distal tip 224 defines a concave void 234 relative to the plane 232 of the distal tip 224. In yet another embodiment, the distal tip 224 may solely have a planar surface 236, in line with the plane 232 of the distal tip 224. The connectivity of the distal tip 224, in each respect, to the yoke 206 is contemplated below. The distal tips 224 may also be curved to fully contact the yoke 206.

Referring to FIG. 4B, the yoke 206 is the radially outermost part of the stator armature assembly 104, serving as a structural and magnetic backbone. It connects the stator teeth 208, which hold the windings 202, and provides a path for the magnetic flux generated by the motor windings 202 to circulate.

The yoke 206 segments 210 a-c are three curved lateral surfaces, however, the number of segments 210 a-c may vary. The segments 210 a-c, when abutting, form a cylinder shape, defining an outer radial surface 236 and an inner radial surface 238, thus having a curved lateral surface thickness 240 extending between the outer radial surface 236 and inner radial surface 238.

Each extremity 242, relative to the arced shape of the segments 210 a-c, may vary in design depending on the configuration of the distal tip 224 of each tooth 208.

The joints 211 may all be the same or each may be different. For example, where the distal tip 224 of a tooth 208 defines a central protuberance 230 extending radially from a plane 232 of the distal tip 224, each extremity 242 of abutting segments 210 a-c may define a tiered step extremity 244. Thus, the tiered step extremities 244 of two abutting segments 210 a-c can affix together, adjoining with the central protuberance 230, while also contacting the central protuberance 230 and the planar surface 236 of the tooth 208. As a result, the joint has an increased surface area that may carry an adhesive or otherwise create a stronger joint. Further, the central protuberance 230 will rotationally locate the segments 210 a-c so that the joints orient in the predetermined, desired locations (e.g., radially above a tooth 208).

“The central protuberance 230 extending from the distal tip 224 engages with the tiered step extremities 244 of yoke segments 210, producing mechanical resistance that prevents relative rotational displacement between the yoke 210 and the wheel 204 when the stator assembly 104 is energized to transmit or react a torque load.

In a further example, where the distal tip 224 of a tooth 208 defines a concave void 234 relative to the plane 232 of the distal tip 224, each extremity 242 of abutting segments 210 a-c may define a respective barb 246. Thus, the barb 246 of two abutting segments 210 a-c can complementarily position within the concave void 234, securing the segments 210 a-c in place.

Again, this arrangement can rotationally locate the segments 210 a-c in an increased surface area joint.

In yet a further example, where the distal tip 224 solely has a planar surface 236 relative to the plane 232 of the distal tip 224, each extremity 242 of abutting segments 210 a-c may define a complementary planar extremity 242. In such a scenario, the abutting segments 210 a-c can be affixed together to the distal tip 224.

It's worth noting that abutting segments 210 a-c can be affixed via the aforementioned methods of planar surface 236 and planar extremity 242, central protuberance 230 and tiered step extremity 244, concave void 234 and barb 246, dovetail joint, or further any form in any combination. In most cases, the extremity 242 of abutting segments 210 a-c and the distal tip 224 of a tooth 208 are glued or welded to secure the yoke 206 relative to the wheel 204.

Around each tooth 208, the stator armature assembly 104 has field windings 202 wrapped therearound. The windings 202 of the electric motor are coils of conductive wire, typically made of copper, that generate magnetic fields when an electric current, provided by the PCB 106 (see FIG. 2), passes through them. These magnetic fields interact with the rotor permanent magnets (not shown) to produce the force needed for rotation of the rotor.

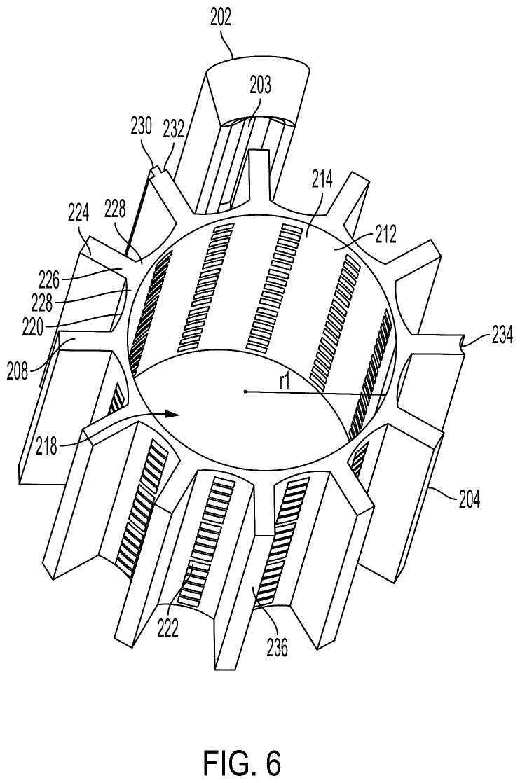

Referring now to FIGS. 6-8, due to the architecture of the wheel 204 and yoke 206, coil or winding 202 can be wound directly around each tooth 208, inside the slots 223, or prepared as a pre-wound coil 202 and inserted around each tooth 208, inside the slots prior to the affixing of the yoke 206 around the wheel 204. For example, referring to FIG. 6, a pre-wound coil or winding 202 is preformed. The winding 202 has a tooth-shaped central passage 203 for snugly and securely receiving the tooth 208 of the wheel 204. The process of mounting a winding 202 one each of the teeth 208 is repeated to create the wheel 204 loaded with windings 202 as shown in FIG. 7.

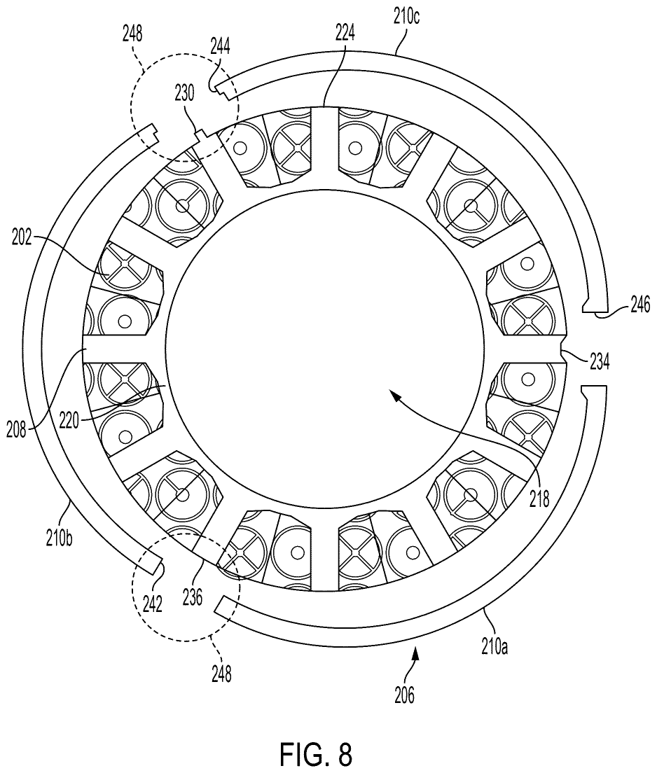

Turning to FIG. 8, the segments 210 a-c of the yoke 206 can thereafter be radially pressed together around the wheel 204 and coil 202. The extremities 242 of the segments 210 a-c are adjusted circumferentially to align with the radial extension, at the distal tip 224, of a tooth 208 of the wheel 204 to form a three intersection points 248 that form the joints 211. By not having to axially insert the wheel 204 into the yoke 206, one can avoid insertion friction, which can cause the laminate to separate, limit the axial length of the motor, breakdown the structural integrity of the interconnections between teeth, limit the tightness of the fit between the yoke and wheel, and the like.

Referring to FIGS. 7-8 together, it is advantageous for abutting segments 210 a-c of the yoke 206 to meet at the distal tip 224 of a tooth 208. In this position 252, there is a relatively lower low flux density concentration, making for a better location for segment 210 a-c joining. Lower flux levels reduce the magnitude of the eddy current that will flow in the shorted lamination, reducing the iron losses from welding the segments 210 a-c. The aforementioned segmentation enables the strategic positioning of the intersection points 248 behind a respective tooth 208 of the wheel 204.

To the contrary, in between adjacent windings 202, a high flux density concentration zone 250 is apparent. Connecting abutting segments 210 a-c together in this zone 250 at a two-point intersection for example would increase the iron losses in the yoke 206 because welding the abutting segments 210 a-c at this high flux density concentration zone 250 shorts lamination sheets together, giving a large path for eddy currents to flow.

Referring back to FIG. 4B, the wheel 204 and yoke 206 are magnetically-permeable structures formed out of stacked, thin, layers of material, such as silicon steel-a type of magnetically-permeable alloy that is highly efficient at conducting magnetic fields while resisting undesired electrical currents. To manufacture the yoke 206 and wheel 204 of the stator armature assembly 104, a die or laser cutter is used to stamp or cut the segments 210a-c and the wheel 204 from sheets of the material. Advantageously, due to the shape and curvature of the segments 210a-c of the present disclosure, the segments 210a-c can be aligned sequentially and compactly relative to the sheet of material and thus cut more efficiently therefrom, reducing material waste. This is in contrast to a yoke formed of only one continuous, circular, structure, as suggested by the prior art, which creates a large central circle of waste material.

The thickness of each lamination is typically between 0.2 mm and 0.5 mm, depending on the specific application, operating frequency, and efficiency requirements. Thinner laminations reduce eddy current losses more effectively, but increase the material cost and increase manufacturing complexity.

As mentioned prior, each lamination of the wheel 204 need not be the same shape. That is, by manufacturing laminations without interconnected bridge portions 220, the circular core 212 can form windows 222 between adjacent teeth 208 improving airflow and heat dissipation and enabling enhanced flux linkage between the windings 202 and rotor (not shown).

Each lamination is coated with a thin layer (microns in thickness) of non-conductive, insulating material to electrically isolate adjacent laminations. The insulating layer is typically made of oxide coating, varnish, or a thin resin. Thus, eddy currents are constrained within each individual lamination, reducing eddy current losses, which occur when the changing magnetic field induces undesired currents within the stator material.

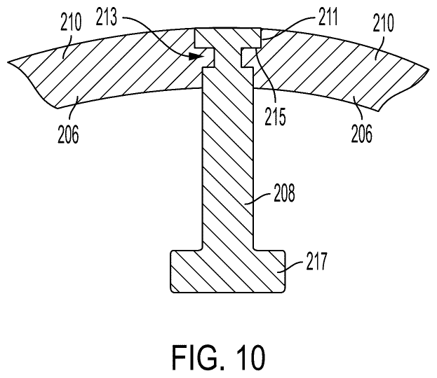

It is also envisioned that many other types of joints may be utilized. For example, FIG. 10 illustrates another version of a joint 211 between a tooth 208 and yoke 206 according to the subject technology. As would be understood, to assemble the joint 211 of FIG. 10, the segments 210 would be slid to rotate about the axis and connect. Each segment 210 has a distal dovetail 213 that can be rectangular as shown or a more aggressive shape to better interlock the segments 210 to the tooth 208. With a more aggressive dovetail shape, the segments may require axial sliding for assembly to each other but may still be sized to assemble to the wheel by radially pressing at least partially. In either case, the joint may provide a simple mechanical connection (i.e., no glue or weld required). The tooth 208 defines opposing channels 215 in a complementary shape to the dovetails 213. In another embodiment, the dovetail joint 211 is only formed on a single side. The tooth 208 includes an expanded base 217.

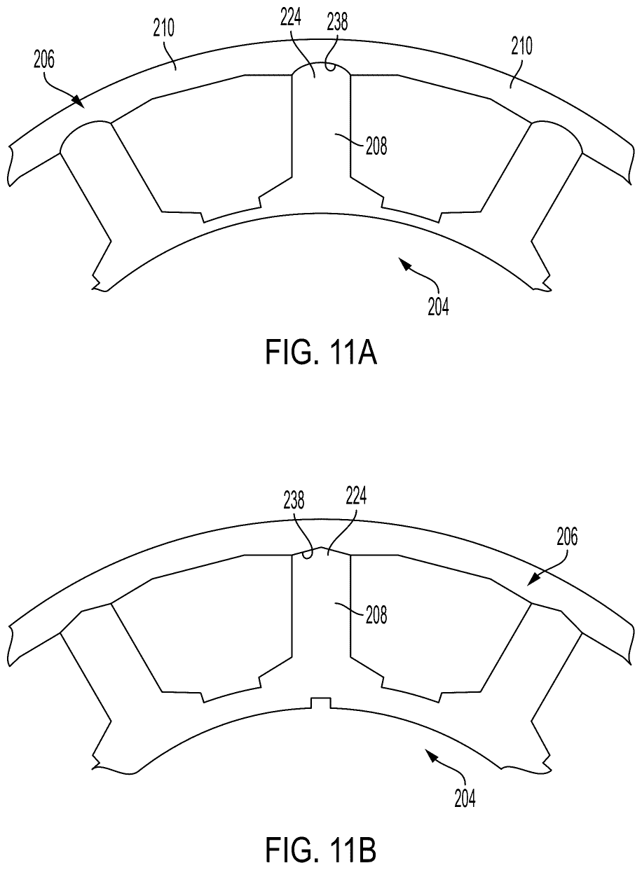

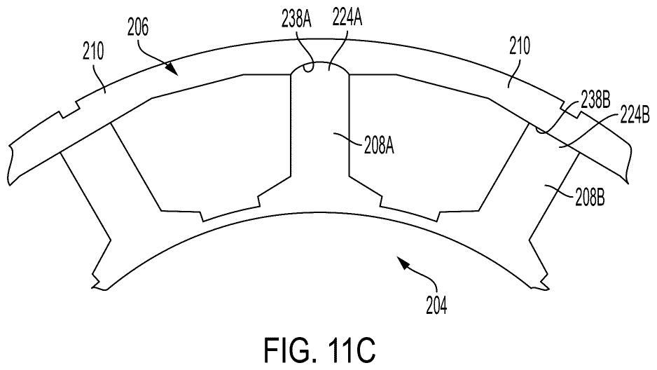

FIG. 11A illustrates an embodiment in which the distal tip 224 of the tooth 208 terminates in a convex arcuate profile, and the inner radial surface 238 of the yoke 206 defines a corresponding concave curvature of substantially equal radius. During radial pressing of the yoke 206 segments 210 into position, the curvature allows the inner surface 238 to contact the tooth 208 progressively, producing distributed contact pressure over the full lamination width rather than at discrete edges. The radius provides a self-centering function that forces the yoke 206 to align concentrically with the wheel 204 as radial displacement occurs, minimizing angular misalignment among adjacent laminations.

The continuous curved interface eliminates sharp corners that would otherwise create localized magnetic flux concentration. The magnetic field transitions smoothly from the tooth 208 into the yoke 206 across the interface, thereby maintaining a uniform flux density and minimizing eddy-current formation. Mechanically, the radiused surface reduces lamination stress during assembly and operation by avoiding point loading, while allowing the yoke 206 to seat under controlled interference. The geometry also accommodates small dimensional deviations without loss of contact area, permitting repeatable press-fit assembly over long axial stack lengths.

FIG. 11B shows an embodiment in which the distal tip 224 of the tooth 208 forms a pointed convex crown rather than the smoothly rounded contour shown in FIG. 11A. The crown of the tooth 208 converges toward an apex, producing a more tapered contact geometry at the distal tip. The inner radial surface 238 of the yoke 206 defines a complementary concave seat that receives the pointed crown so that, during radial pressing of the segments 210 into position, initial engagement occurs at the apex and progressively broadens along the flanks of the tooth as the yoke 206 is seated to its final depth. This pointed configuration promotes a distinct self-centering action during assembly, ensuring that the yoke 206 aligns concentrically with the wheel 204 and maintaining uniform circumferential spacing among laminations.

The pointed tooth interface also modifies the local pressure distribution and magnetic behavior relative to the curved interface of FIG. 11A. Concentrated contact at the apex during insertion provides enhanced guidance but transitions to full-area contact once seated, distributing the compressive load evenly and preventing edge fretting between laminations. Magnetically, the tapered crown directs flux efficiently into the concave seat of the yoke 206, producing a smooth flux transition with low reluctance and minimal eddy-current generation. The concave seat may include shallow reliefs along its flanks to alleviate flux crowding and accommodate minor tolerance variations without loss of contact area. For bonded assemblies, adhesive can be dispensed into the concave seat without forming wedge gaps at the edges, and for welded assemblies, the pointed crown provides a stable weld land while keeping the joint in a lower-flux region above the tooth 208.

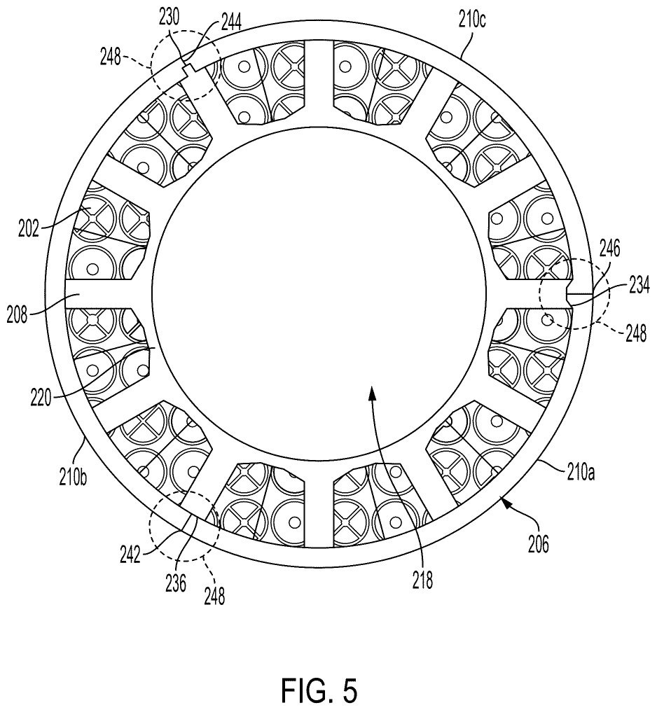

FIG. 11C illustrates an embodiment in which adjacent teeth 208A and 208B alternate between curved and planar interface geometries. Tooth 208A terminates in a convex arcuate distal tip 224A similar to that described in FIG. 11A, while the subsequent tooth 208B terminates in a planar distal tip 224B similar to that described in FIGS. 4B, 5, 8, among others. The inner radial surfaces 238A, 238B of the yoke 206 defines alternating concave and planar seating regions arranged circumferentially to correspond with the alternating tooth geometries. Each concave region of the yoke 206 receives the curved tip 224A of a tooth 208A, and each adjacent planar region of the yoke 206 seats against the flat tip 224B of a tooth 208B. During radial pressing of the yoke 206 segments 210 around the wheel 204, the alternating geometry causes successive teeth to establish contact under different mechanical and magnetic boundary conditions. The curved interfaces of the teeth 208A provide automatic radial centering and uniform compression distribution, while the planar interfaces of the teeth 208B define fixed radial depth and limit total interference. This arrangement enables controlled clamping pressure across the circumference of the stator while maintaining consistent overall circularity of the yoke 206.

The alternating curved and planar interfaces also influence the magnetic flux distribution. The curved regions promote smooth flux entry into the yoke 206 with minimal reluctance, while the planar regions stabilize the overall path length and reduce cumulative angular flux distortion around the stator periphery. The combination therefore achieves high concentricity and balanced flux continuity without requiring machining or post-assembly grinding. The alternating pattern of teeth 208A and 208B may repeat uniformly around the circumference, and the transition between adjacent curved and planar regions may include short filleted blends in the yoke 206 to relieve shear stress between consecutive contact geometries. This alternating arrangement allows the mechanical and magnetic advantages of both interface types—self-centering curvature and rigid planar registration—to be realized simultaneously within a single stator assembly.

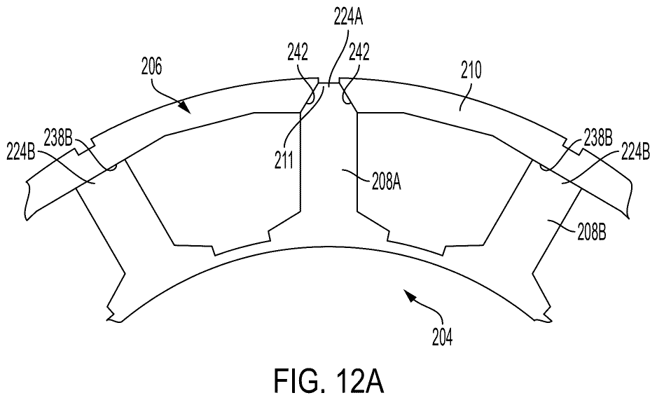

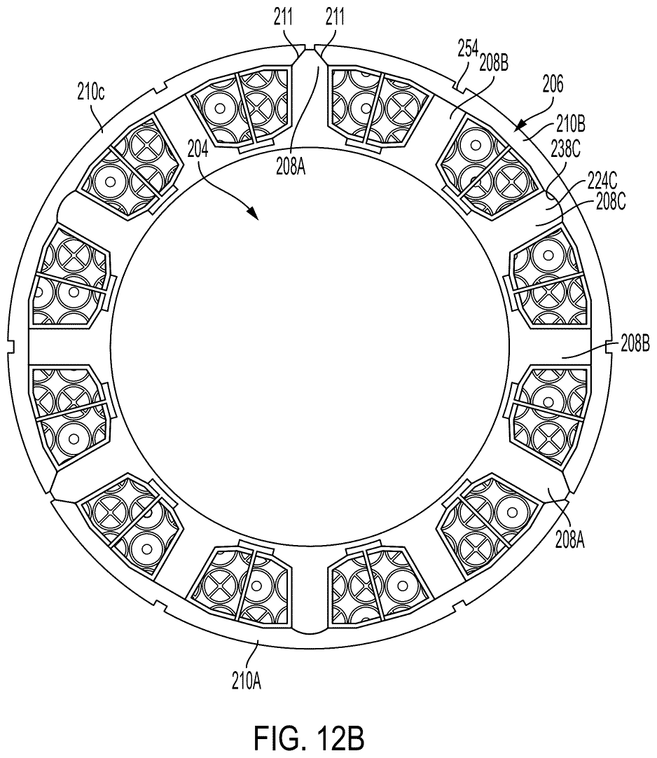

FIG. 12A illustrates an embodiment in which the abutting ends 242 of adjacent yoke segments 210 are cut along complementary bevels that meet over teeth 208A having alternating upper surface geometries. In this configuration, certain teeth 208A include a distal tip 224A with an inclined or beveled crown shape that mates with the oblique seam of the abutting ends 242 of adjacent yoke segments 210. Adjacent teeth 208B terminate in a planar distal tip 224B similar to that described in FIGS. 4B, 5, 8, 11C, among others. The result is a repeating pattern of bevel-supported and planar-supported joints arranged circumferentially around the stator, similar in concept to the alternating curved and planar interfaces described with respect to FIG. 11C. Each beveled tooth 208A provides an angled planar land that supports the mitred seam between the segment ends 242, while each planar tooth 208B provides a flat seating surface that maintains radial dimensional uniformity between adjacent joints 211. The resulting interface between tooth 208A and the adjacent yoke segments 210 forms oblique joints 211 oriented at acute angles relative to the radial direction.

Under hoop compression, tangential forces acting on the yoke 206 are resolved into components along the bevel surfaces, producing inward clamping on the teeth 208A and preventing relative slip of the adjoining segment ends. The oblique seams increase weld length relative to perpendicular butt joints, distributing thermal and mechanical stresses more uniformly through the lamination stack. The alternating arrangement of beveled and planar joints equalizes stiffness and prevents periodic distortion that could occur if all joints were oriented identically. The angular orientation of each weld line with respect to the magnetic flux path minimizes local flux disruption and confines any induced eddy currents to small closed loops within individual laminations. Small reliefs (not distinctly shown) may be formed at the outer edges of the bevels to prevent burr interference during radial insertion and to capture molten material during welding. This alternating geometry therefore combines the structural strength of beveled joints with the dimensional stability of planar seats, providing both mechanical rigidity and low magnetic loss in the region of each joint.

FIG. 12B illustrates a cross-sectional view of the stator armature assembly incorporating the joint configuration described in FIGS. 11A-12A, among other places. In this embodiment, the wheel 204 includes a repeating pattern of teeth 208A, 208B, and 208C that define distinct interface geometries with the surrounding yoke 206. A first tooth 208A includes a distal tip 224A having the inclined or beveled crown shape that supports an oblique joint 211 between adjoining yoke segments 210 and 210. Immediately following, a tooth 208B includes a planar distal tip 224B that seats flush against a flat inner surface of the yoke 206, establishing a stable radial reference surface between adjacent joints. The next tooth 208C includes a distal tip 224C with a convex arcuate profile, and the inner radial surface 238C of the yoke 206 defines a corresponding concave curvature that closely conforms to the rounded tooth shape. Beyond this curved interface, another planar tooth 208B and beveled tooth 208A appear in sequence, repeating the same geometric progression around the stator armature assembly.

The pattern of beveled, planar, and curved teeth-208A, 208B, 208C, 208B, 208A, and so on-creates a circumferentially balanced structure in which each type of tooth performs a specific function. The beveled teeth 208A provide angled support directly beneath the joints 211, allowing the oblique seams between segment ends to carry compressive hoop loads without slip. The planar teeth 208B maintain uniform spacing and dimensional control, ensuring a consistent radial air gap around the wheel 204. The curved teeth 208C promote smooth magnetic flux transfer into the yoke 206 by eliminating abrupt changes in field direction at the interface. This sequence distributes both mechanical and magnetic loading evenly, reducing localized stress and flux concentration that could otherwise occur if identical teeth were repeated throughout. In combination, the alternating tooth geometries and corresponding yoke surfaces yield a stator assembly that is structurally balanced, magnetically uniform, and precisely concentric around its circumference.

In the embodiments shown in FIG. 12B, the outer radial edge of the yoke 206 includes a shallow circumferential indentation or recess 254. This indentation 254 locally reduces the yoke 206 outer cross-section, providing several mechanical and magnetic advantages. Structurally, the recess 254 functions as a compliant relief that absorbs hoop strain generated during radial pressing and thermal cycling, preventing distortion of the inner magnetic path and maintaining uniform contact pressure between the yoke 206 and the teeth 208. The reduced mass along the outer periphery also improves dynamic balance of the assembled stator, minimizing vibration at high rotational speeds. Magnetically, the indentation 254 interrupts minor eddy-current loops that would otherwise circulate near the outer lamination edges, thereby lowering parasitic losses and enhancing overall motor efficiency. Additionally, the recess 254 serves as a visual and geometric reference feature that aids in segment alignment during assembly while maintaining the continuous inner surface 238 required for uninterrupted flux conduction around the stator circumference.

It will be appreciated by those of ordinary skill in the pertinent art that the functions of several elements can, in alternative embodiments, be carried out by fewer elements, or a single element. Similarly, in some embodiments, any functional element can perform fewer, or different, operations than those described with respect to the illustrated embodiment. Also, functional elements shown as distinct for purposes of illustration can be incorporated within other functional elements in a particular embodiment.

While the subject technology has been described with respect to various embodiments, those skilled in the art will readily appreciate that various changes and/or modifications can be made to the subject technology without departing from the scope of the present disclosure.

What is claimed is:

1. A stator armature assembly for an electromagnetic motor comprising:
a wheel having a plurality of radial teeth;
a plurality of windings, each winding mounted on a respective one of the plurality of radial teeth; and
a yoke comprising at least two segments joined together and radially disposed around the wheel and the plurality of windings.

2. The stator armature assembly of claim 1, wherein the at least two segments define curved lateral surfaces that, when abutting, contact a distal tip of each of the plurality of radial teeth and together form a cylindrical ring radially disposed around the wheel.

3. The stator armature assembly of claim 1, wherein at least one tooth defines a central protuberance extending radially from a plane of a distal tip thereof, a concave void inward of the plane, or a planar surface at the distal tip, and the at least two segments respectively define tiered step extremities, barb extremities, or planar extremities complementary to the corresponding tooth features.

4. The stator armature assembly of claim 1, wherein the at least two segments of the yoke join radially above at least one of the plurality of radial teeth.

5. The stator armature assembly of claim 1, wherein each segment end is beveled and the segment ends meet along an oblique seam positioned radially above a tooth having an angled upper surface that supports the seam.

6. The stator armature assembly of claim 1, wherein the distal tip of at least one tooth is curved and the inner radial surface of the yoke defines a complementary concave seat that progressively engages the distal tip during radial pressing.

7. The stator armature assembly of claim 1, wherein the distal tip of at least one tooth is pointed and the inner radial surface of the yoke defines a complementary concave seat that progressively engages the pointed distal tip during radial pressing.

8. The stator armature assembly of claim 1, wherein adjacent teeth alternate between (i) a tooth having a curved distal tip and (ii) a tooth having a planar distal tip, and the inner radial surface of the yoke defines circumferentially alternating concave and planar seating regions respectively aligned with the alternating teeth.

9. A stator for an electric motor comprising:
a wheel having a first number of teeth and slots separating the teeth;
electric coils disposed in the slots to define motor phases; and
a yoke including a second number of segments configured to be radially pressed into a fixed position around the wheel, wherein the first number is a multiple of the second number.

10. The stator of claim 9, wherein the first number and second number are selected from the following combinations: (6, 2 or 3), (9, 3), (12, 2 to 4), (15, 3 or 5), (18, 2 to 6), (24, 2 to 4), or (27, 3).

11. The stator armature assembly of claim 1, wherein adjoining segment ends are welded, adhesively bonded, or mechanically interlocked.

12. The stator armature assembly of claim 1, wherein the yoke is formed of three arcuate segments arranged circumferentially around the wheel.

13. A stator for an electric motor comprising:
a tooth wheel laminated stack defining a circular core and a plurality of teeth extending radially from the circular core, each tooth wound with an electric coil; and
a yoke, each segment of the yoke radially disposed around the wheel, each segment joining an adjacent segment at a location abutting a tooth of the plurality of teeth, wherein the circular core includes at least one bridge between adjacent teeth.

14. The stator of claim 13, wherein the at least one bridge defines a window to adjust distribution of magnetic flux in the stator.

15. The stator of claim 13, wherein the yoke segments are radially pressed together around the wheel to form intimate contact with the plurality of teeth.
